(19) United States
(12) Patent Application Publication
(10) Pub. No.: US 2017/0136999 A1
(43) Pub. Date: May 18, 2017

(54) A WINDSCREEN WIPER DEVICE

(71) Applicant: FEDERAL-MOGUL S.A., AUBANGE (BE)

(72) Inventor: THOMAS FRISCIONI, MEXY (FR)

(21) Appl. No.: 15/321,941

(22) PCT Filed: Jul. 3, 2014
(86) PCT No.: PCT/EP2014/064191

§ 371 Date: Dec. 23, 2016

(51) Int. Cl. B60S 1/40; B60S 1/38

(52) U.S. Cl. CPC B60S 1/4048; B60S 1/3849; B60S 2001/3898

(57) ABSTRACT

A windscreen wiper device of the flat blade type includes an elastic, elongated carrier element, as well as an elongated wiper blade of a flexible material and a connecting device for an oscillating arm and a joint part comprising one resilient tongue arranged to engage into a correspondingly shaped hole provided in a base of a U-shaped cross-section of said oscillating arm. The resilient tongue includes a first step and a second step, wherein said first step is arranged to abut an edge of said hole of an oscillating arm (1) of a first type and said second step is arranged to abut an edge of said hole of an oscillating arm (1′) of a second type, wherein said oscillating arm of the first type (1) and said oscillating arm (1′) of the second type mutually differ in a distance between legs of the U-shaped cross-section of said oscillating arms.

### BACKGROUND

1. Technical Field

The present invention relates to a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near one end, with the interposition of a joint part, wherein the joint part comprises at least one resilient tongue arranged to engage into a correspondingly shaped hole provided in a base of a U-shaped cross-section of the oscillating arm, wherein the resilient tongue is hingeable between a inward position, wherein the wiper blade can be released from the oscillating arm, and an outward position, wherein the wiper blade can be retained on the oscillating arm.

2. Related Art

In use, the oscillating arm is connected to a mounting head mounted on a drive shaft, wherein the oscillating arm at one end thereof is pivotally connected to the mounting head by means of a pivot pin and at another end thereof is connected to the wiper blade placed in abutment with the windscreen to be wiped.

In use, the shall rotates alternately in a clockwise and in a counter-clockwise sense carrying the mounting head into rotation also, which in turn draws the oscillating arm into rotation and by means of the connecting device moves the wiper blade, the oscillating arm can thus oscillate to-and-from between a first reversal position and a second reversal position. In the first reversal position the oscillating arm extends parallel to a windscreen to be wiped and is located near a lower edge of the windscreen to be wiped. Also, in the second reversal position the oscillating arm extends also parallel to a windscreen to be wiped and is located in a central region or near a side edge of the windscreen to be wiped.

The present invention also relates to a vehicle equipped with such a windscreen wiper device, as well as to a method for manufacturing such a windscreen wiper device.

It is noted that the present invention is not restricted to automobiles, but also refers to rail coaches and other (fast) vehicles.

Such a windscreen wiper device is generally known from European patent publication no. 1 403 156 of the same Applicant. This prior art windscreen wiper device is designed as a “yokeless” wiper device or “flat blade”, wherein no use is made of several yokes pivotally connected to each other, but wherein the wiper blade is biased by the carrier element, as a result of which it exhibits a specific curvature. In this prior art windscreen wiper device the joint part comprises at least one resilient tongue engaging in a correspondingly shaped hole provided in the oscillating arm, wherein the resilient tongue is rotatable along an hinge axis between an outward position retaining the wiper blade onto the oscillating arm and an inward position releasing the wiper blade from the oscillating arm. In order to connect the wiper blade onto the oscillating arm, the resilient tongue is initially pushed in against a spring force—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm. In practice this interconnection between the joint part and the oscillating arm is called a bayonet connection.

### SUMMARY OF THE INVENTION

The object of the invention is to provide an improved windscreen wiper device at minimum costs—without using complex machinery and additional tools—, while the connecting device and the oscillating arm can be interconnected in a reliable and secure manner, using less parts.

In order to accomplish that objective, a windscreen wiper device of the type referred to in the introduction is characterized according to the invention in that the resilient tongue comprises a first step and a second step, wherein the first step is arranged to abut an edge of the hole of an oscillating arm of a first type facing towards a free end thereof, wherein the second step is arranged to abut an edge of the hole of an oscillating arm of a second type facing towards a free end thereof, and wherein the oscillating arm of the first type and the oscillating arm of the second type mutually differ in a distance between legs of the U-shaped cross-section of the oscillating arms. Preferably, an upper surface of the first step is located closer to the wiper blade (and in use thus to a windscreen to be wiped) than an upper surface of the second step.

Preferably, the joint part is detachably connected to the connecting device particularly through a snapping/clipping operation. In particular, the snapping operation is realized by pivotally engaging protrusions of the connecting device at the location of the pivot axis into recesses provided in the joint part. More in particular, the joint part has an at least substantially U-shaped cross-section at the location of its attachment to the connecting device, wherein each leg of the U-shaped cross-section is provided with a recess provided coaxially with the pivot axis. Further, the protrusions that function as bearing surfaces, are spaced far apart, so that the forces exerted thereon will be relatively low.

the joint part is arranged to be connected to the connecting device for different U-shaped cross-sections of the oscillating arm, wherein the joint part is subsequently connected to the connecting device by the pivotally engaging protrusions of the connecting device, at the location of the pivot axis, in the recesses provided in the joint part, and wherein the oscillating arm can be subsequently connected to the joint part. The essence of the present invention is that the connecting device and the joint part each are a universal connection part for each type of U-shaped cross-section of the oscillating arm. A same type of the joint part to be connected to a same type of the connecting device may be used for each different type of U-shaped cross-section of the oscillating arm. The advantage achieved by the invention is that a unit consisting of the wiper blade, the connecting device and the joint part connected to the connecting device can be manufactured for each and every type of U-shaped cross-section of the oscillating arm. Thus, a universal connection between the wiper blade and the oscillating arm is obtained, so that car drivers are given the possibility to buy also non-original cheap wiper blades fitting the original oscillating arms on their cars. As indicated above, the U-shaped cross-sections of the oscillating arms mutually differ as far as the distance between the legs of the U-shaped cross-section of the respective oscillating arm is concerned. In particular, the distance in the oscillating arm of the first type is 22 mm, while the distance in the oscillating arm of the second type is 19 mm.

The present invention thus provides a universal connecting unit (consisting of the connecting device and the joint part) that is firmly attached to the oscillating arm.

In a preferred embodiment of a windscreen wiper device in accordance with the invention the joint part has an at least substantially U-shaped cross-section at a location of its attachment to the connecting device, wherein at least one leg of the U-shaped cross-section of the joint part comprises an attaching lug, and wherein the attaching lug is arranged to snappingly engage a corresponding leg of the U-shaped cross-section of the oscillating arms of the first type and the second type. Preferably, both legs are equipped with such an attaching lug, the attaching lug forms a flexible articulation.

In a further preferred embodiment of a windscreen wiper device according to the invention the attaching lug comprises a protrusion extending laterally inwardly, wherein the attaching lug is hingeable between a downward position, wherein the wiper blade can be released from the oscillating arm of the first type and the second type, and an upward position, wherein the wiper blade can be retained on the oscillating arms of the first type and the second type and wherein the protrusion is arranged to snap behind the corresponding leg of the U-shaped cross-section of the oscillating arms of the first type and the second type. Particularly, the joint part comprises a cam, wherein the cam and the attaching lug are arranged to longitudinally retain between them the legs of the U-shaped cross-section of the oscillating arm of the first type.

In a further preferred embodiment of a windscreen wiper device in accordance with the invention the attaching lug comprises a protrusion extending laterally inwardly, wherein the attaching lug can be pushed in and out in longitudinal direction between a inward position, wherein the wiper blade can be released from the oscillating arms of the first type and the second type, and an outward position, wherein the wiper blade can be retained on the oscillating arms of the first type and the second type and wherein the protrusion is arranged to snap into a correspondingly shaped recess of the corresponding leg of the U-shaped cross-section of the oscillating arms of the first type and the second type. Preferably, the connecting device comprises a cam, wherein the cam and the attaching lug are arranged to longitudinally retain between them the legs of the U-shaped cross-section of the oscillating arm of the second type. Pushing in and out may be carried out manually.

In a further preferred embodiment of a windscreen wiper device according to the invention each leg of the U-shaped cross-section of the oscillating arms of the first type and the second type comprises clamping members engaging around longitudinal sides of the joint part that face away from each other. Hence, a locking of the wiper blade in transverse direction (in use perpendicular to a windscreen to be wiped) is ensured. the clamping members are preferably formed by bended edges of the legs of the U-shaped cross-section and are in one piece therewith.

the joint part is preferably made in one piece of plastic.

As mentioned earlier, the present invention also refers to a vehicle provided with a windscreen wiper device in accordance with the invention.

The present invention is also directed to a method for manufacturing a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near one end, with the interposition of a joint part, wherein the joint part comprises at least one resilient tongue arranged to engage into a correspondingly shaped hole provided in a base of a U-shaped cross-section of the oscillating arm, wherein the resilient tongue is hingeable between a inward position, wherein the wiper blade can be released from the oscillating arm, and an outward position, wherein the wiper blade can be retained on the oscillating arm, characterized in that the resilient tongue comprises a first step and a second step, wherein the first step is arranged to abut an edge of the hole of an oscillating arm of a first type facing towards a free end thereof, wherein the second step is arranged to abut an edge of the hole of an oscillating arm of a second type facing towards a free end thereof, and wherein the oscillating arm of the first type and the oscillating arm of the second type mutually differ in a distance between legs of the U-shaped cross-section of the oscillating arms.

### THE DRAWINGS

The invention will now be explained more in detail with reference to figures illustrated in a drawing, wherein

FIG. 1 shows several schematic views of an oscillating arm to be used in a windscreen wiper device of the flat blade type according to the invention;

FIG. 2 shows a perspective, schematic view of a connecting device together with a joint part in a preferred embodiment according to the invention to be used in a windscreen wiper device of the flat blade type;

FIG. 3 shows a perspective and side view of the connecting device together with the joint part of FIG. 2, all with (a part of) an oscillating arm of the first type and the second type, respectively;

FIGS. 4 and 5 show a side view of the connecting device together with the joint part of FIG. 2 arranged to be connected to an oscillating arm of the first type and the second type, respectively;

FIGS. 6 and 7 show a perspective view of an interconnection between the joint part and the oscillating arm of the first type (22 mm) of FIG. 2; -FIG. 8 shows several views of another interconnection between the joint part and the oscillating arm of FIG. 2;

FIG. 9 corresponds to FIG. 5 (referring to an oscillating arm of the second type (19 mm);

FIG. 10 corresponds to FIG. 4 (referring to an oscillating arm of the first type (22 mm); and

FIG. 11 corresponds to FIGS. 6 and 7 (but now referring to an oscillating arm of the second type (19 mm)).

### DETAILED DESCRIPTION

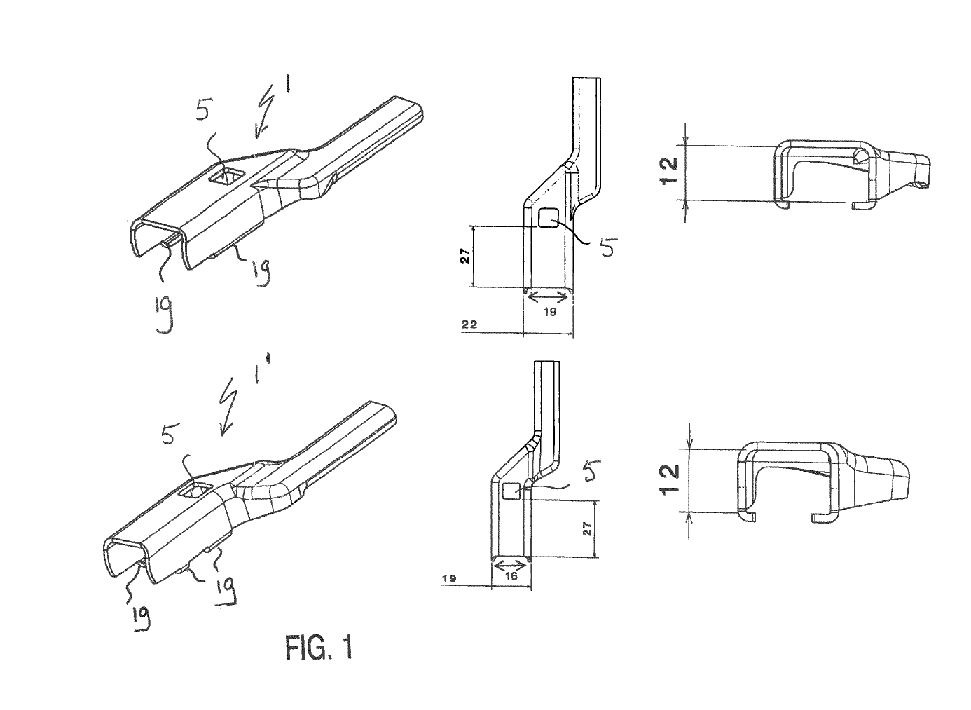

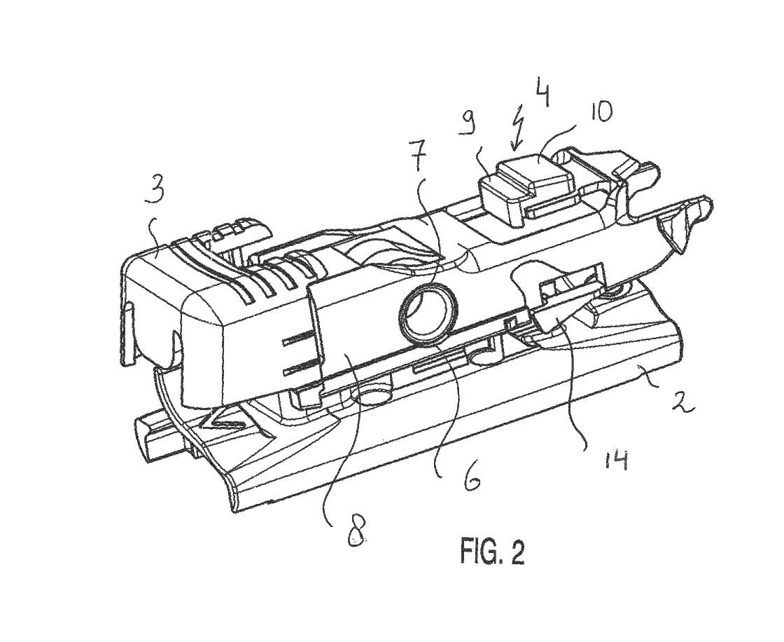

FIG. 1 shows several schematic views of (a part of) an oscillating arm 1 to be used in a windscreen wiper device of the flat blade type according to the invention. Such a windscreen wiper device of the flat blade type is typically built up of an elastomeric (rubber) wiper blade comprising a central longitudinal groove, wherein a longitudinal strip made of spring band steel is fitted in the longitudinal groove, the strip forms a flexible carrier element for the rubber wiper blade, as it were, which is thus biased in a curved position (the curvature in operative position being that of a windscreen to be wiped). Usually an end of the strip and/or an end of the wiper blade is connected on either side of the windscreen wiper device to respective connecting pieces or “end caps”. The connecting pieces may be formed as separate constructional elements, which may be form-locked as well as force-locked to both ends of the strip and/or ends of the wiper blade. In the alternative, the connecting pieces may be in one piece with the strip made of spring band steel. The windscreen wiper device is furthermore built up of a connecting device 2 of metal for connecting the oscillating wiper arm 1 thereto, with the interposition of a joint part 3 (FIG. 2) The oscillating wiper arm I is pivotally connected to the connecting device 2 about a pivot axis near one end.

In FIG. 1 two oscillating arms 1,1′ are shown, namely an oscillating arm 1 of the first type and an oscillating arm 1′ of the second type mutually differing in a distance between legs of an U-shaped cross-section of the oscillating arms 1,1′. As depicted, the distance in the oscillating arm 1 of the first type is 22 mm, while the distance in the oscillating arm 1′ of the second type is 19 mm.

As can be seen in FIG. 2, the joint part 3 comprises a resilient tongue 4 extending outwardly, while the oscillating arm 1,1′ has the U-shaped cross-section at the location of its connection to the joint part 3, so that the tongue 4 engages in an identically shaped hole 5 provided in a base of the U-shaped cross-section. The connecting device 2 with the wiper blade is mounted onto the oscillating arm 1,1′ as follows. The joint part 3 being already clipped onto the connecting device 2 is pivoted relative to the connecting device 2, so that the joint part 3 can be easily slid on a free end of the oscillating arm 1,1′. During this sliding movement the resilient tongue 4 is initially pushed in against a spring force and then allowed to spring back into the hole 5, thus snapping, that is clipping the resilient tongue 4 into the hole 5. This is a so-called bayonet-connection. The oscillating arm 1,1′ together with the joint part 3 may then be pivoted back in a position parallel to the wiper blade in order to be ready for use. By subsequently pushing in again the resilient tongue 4 against the spring force (as if it were a push button), the connecting device 2 and the joint part 3 together with the wiper blade may be released from the oscillating arm 1,1′. Dismounting the connecting device 2 with the wiper blade from the oscillating arm 1,1′ is thus realized by sliding the connecting device 2 and the joint part 3 together with the wiper blade in a direction away from the oscillating arm 1,1′.

Although not shown in FIG. 1, but fully understood by a skilled person, the oscillating arm 1,1′ is connected to a mounting head fixed for rotation to a shaft driven by a small motor. In use, the shaft rotates alternately in a clockwise and in a counter-clockwise sense carrying the mounting head into rotation also, which in turn draws the oscillating arm 1,1′ into rotation and by means of the connecting device 2 moves the wiper blade.

In FIG. 2 is depicted a unit consisting of a connecting device 2 and a joint part 3 detachably and pivotally connected thereto according to the invention, wherein the unit is universal part in the sense that it can be used for each and every type of oscillating arm 1,1′ with a U-shaped cross-section, that is, for example, for the oscillating arm 1 of the first type on the one hand and for the oscillating arm 1′ of the second type on the other hand, the connecting device 2 is particularly welded, soldered, glued or clamped onto two spaced-apart longitudinal strips disposed on opposite sides in longitudinal grooves of the wiper blade. In the alternative or in addition thereto, the connecting device 2 is connected to the elastomeric (rubber) material of the wiper blade, for example glued or clamped. As can be seen in FIG. 2, the connecting device 2 comprises two cylindrical protrusions 6 extending outwardly on either side thereof. These protrusions 6 pivotally engage in identically shaped cylindrical recesses 7 in legs 8 of a U-shaped cross-section of the joint part 3. the protrusions 6 function as bearing surfaces at the location of the pivot axis in order to pivot the joint part 3 (and the oscillating arm 1,1′ attached thereto) about the pivot axis near one end of the oscillating arm 1,1′. The protrusions 6 are preferably in one piece with the connecting device 2. In the alternative the protrusions 6 are part of a separate pin to be inserted into opposite holes in sidewalls of the connecting device 2 (not shown).

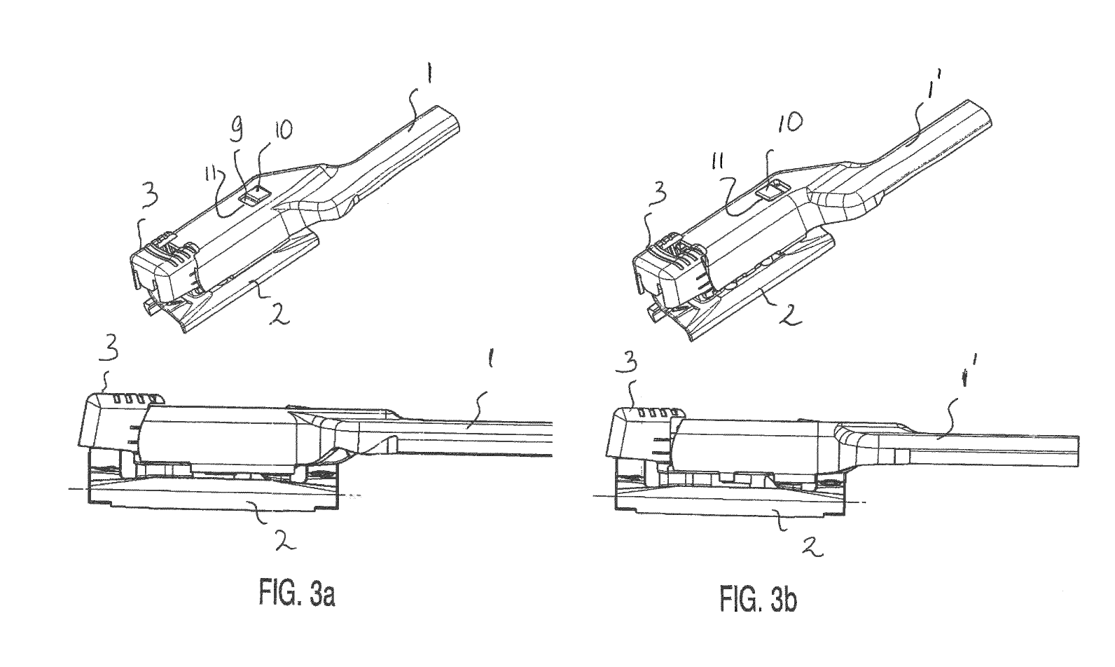

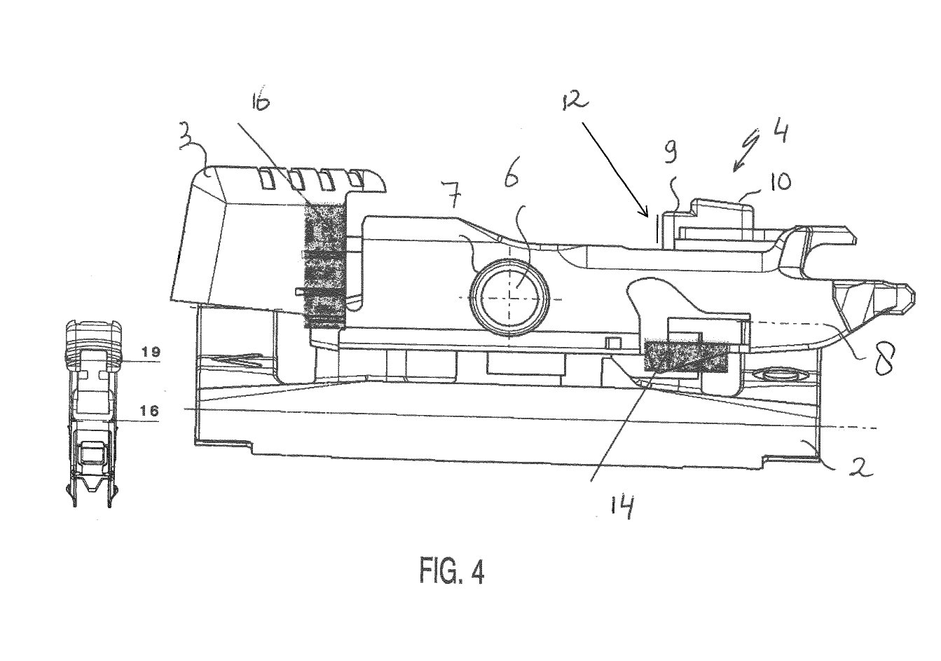

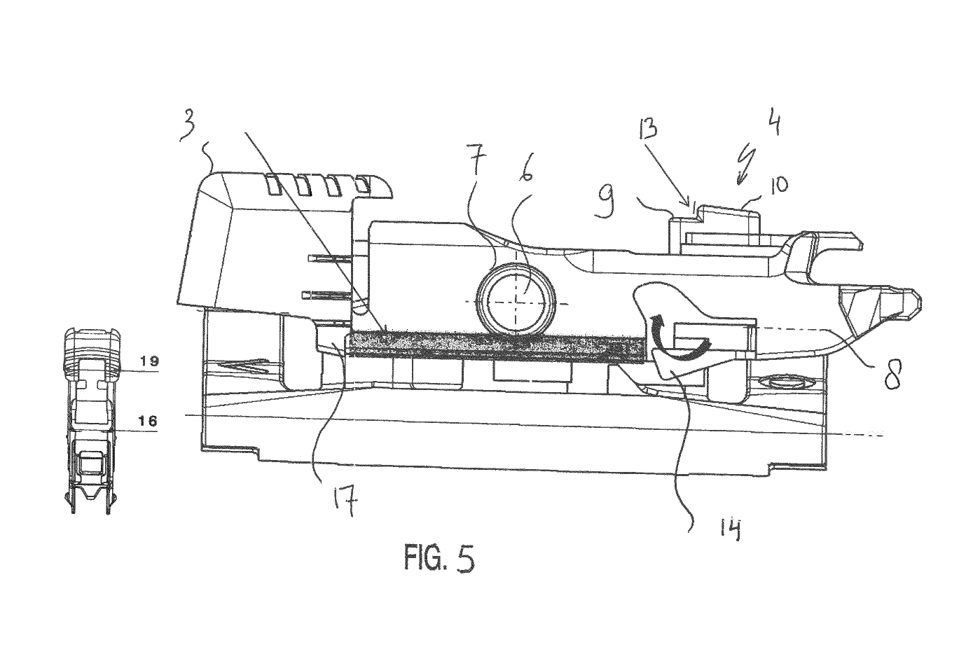

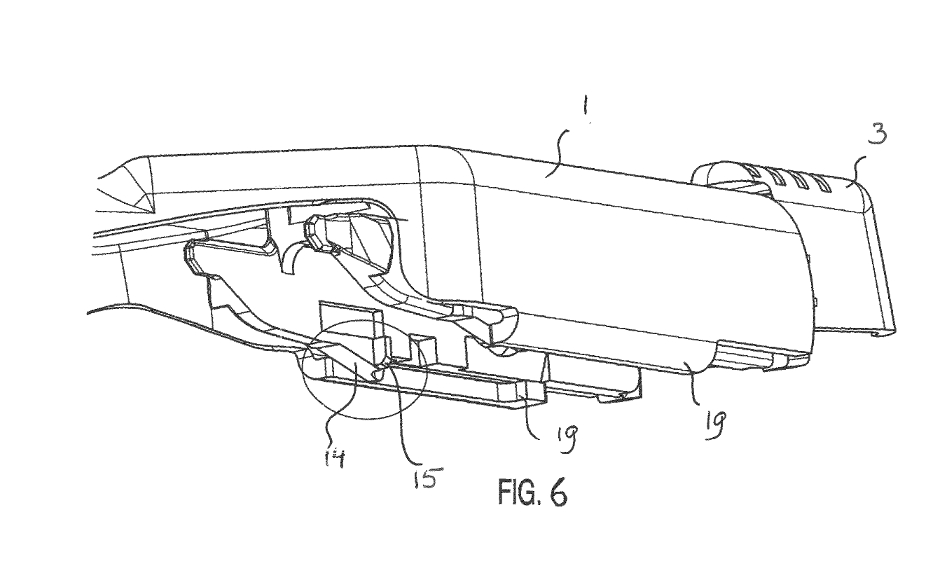

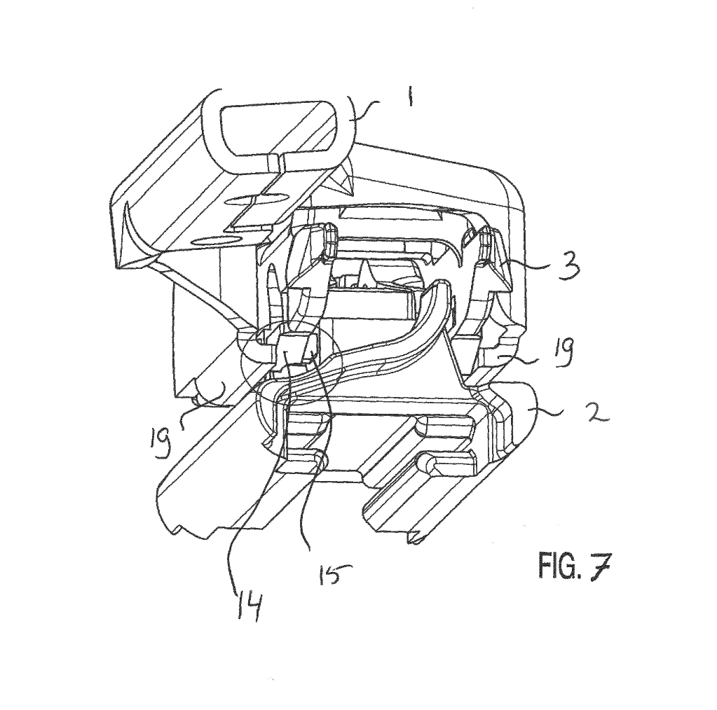

As depicted in FIGS. 2, 3 and 4, the resilient tongue 4 of the joint part 3 comprises a first step 9 and a second step 10 as if it were a staircase. the first step 9 is arranged to abut an edge 11 of the hole 5 of the oscillating arm 1 of a first type facing towards a free end thereof. the second step 10 is arranged to abut also the edge 11 of the hole 5 of the oscillating arm 1′ of a second type. In FIGS. 4 and 5 sides of the steps 9,10 are indicated with reference numerals 12,13, respectively, which abut the edge 11 of the hole 5 in case an oscillating arm 1 of the first type or an oscillating arm 1′ of the second type is used. As shown in FIG. 4, the legs 8 of the U-shaped cross-section of the joint part 3 each comprises an attaching lug 14. the attaching lug 14 is arranged to snappingly engage a corresponding leg of the U-shaped cross-section of the oscillating arms 1,1′ of the first type and the second type. With reference to FIG. 6, the attaching lug 14 comprises a protrusion 15 extending laterally inwardly, wherein the attaching lug 14 is hingeable between a downward position (FIG. 5), wherein the wiper blade can be released from the oscillating arms 1,1′ of the first type and the second type, and an upward position (FIG. 4), wherein the wiper blade can be retained on the oscillating arms 1,1′ of the first type and the second type. In the upward position the protrusion 15 is arranged to snap behind the corresponding leg of the U-shaped cross-section of the oscillating arm 1 of the first type. Reference is made to FIGS. 4 and 6.

In case of an oscillating arm I of the first type, the legs of the U-shaped cross-section of the oscillating arm 1 of the first type are clamped between a cam 16 on the joint part 3 and the attaching lug 14 in order to ensure locking thereof in longitudinal direction, wherein reference is made to FIG. 4. When an oscillating arm 1′ of the second type is used, the legs of the U-shaped cross-section of the oscillating arm 1′ of the second type are clamped between a cam 17 on the connecting device 2 and the attaching lug 14 in order to ensure locking thereof in longitudinal direction, wherein reference is made to FIG. 5.

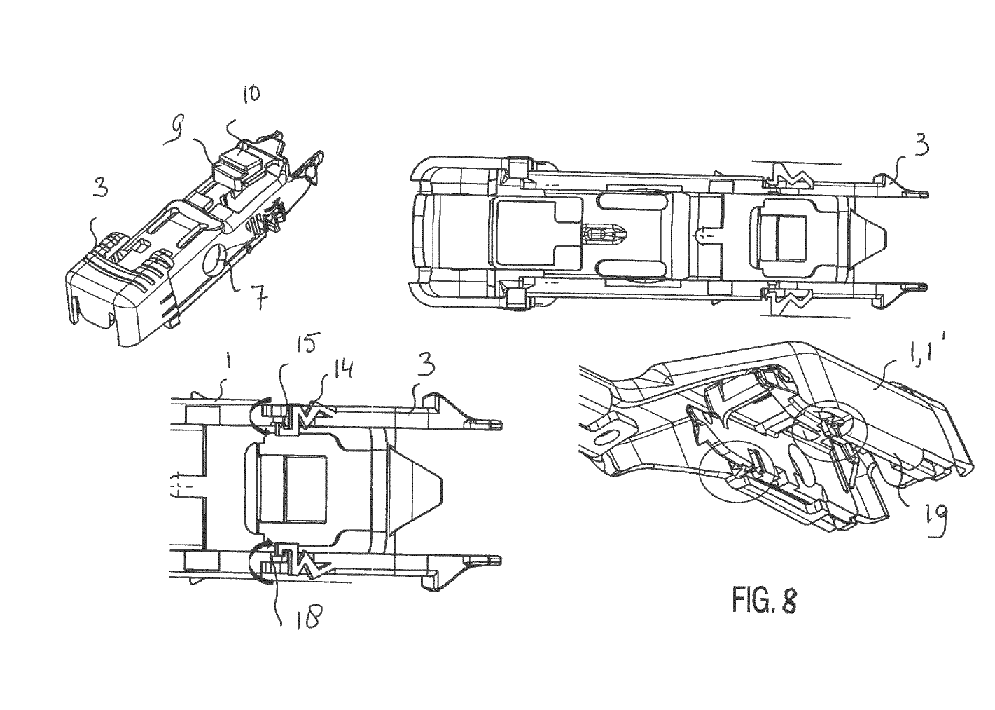

Parts in FIGS. 7 and 8 that correspond to their counterparts in FIGS. 1 through 6 have been designated with the same reference numerals. In the embodiment of FIG. 8, the attaching lug 14 also comprises a protrusion 15 extending laterally inwardly. However, the attaching lug 14 can now be pushed in and out in longitudinal direction between a inward position, wherein the wiper blade can be released from the oscillating arm 1 of the second type, and an outward position, wherein the wiper blade can be retained on the oscillating arm 1′ of the second type and wherein the protrusion 15 is arranged to snap into a correspondingly shaped recess 18 of the corresponding leg of the U-shaped cross-section of the oscillating arm 1′ of the second type. With reference to FIGS. 1, 6, 7 and 8 each leg of the U-shaped cross-section of the oscillating arms 1,1′ of the first type and the second type comprises integral therewith clamping members 19 in form of edges bended inwardly engaging around longitudinal sides of the joint part 3 that face away from each other.

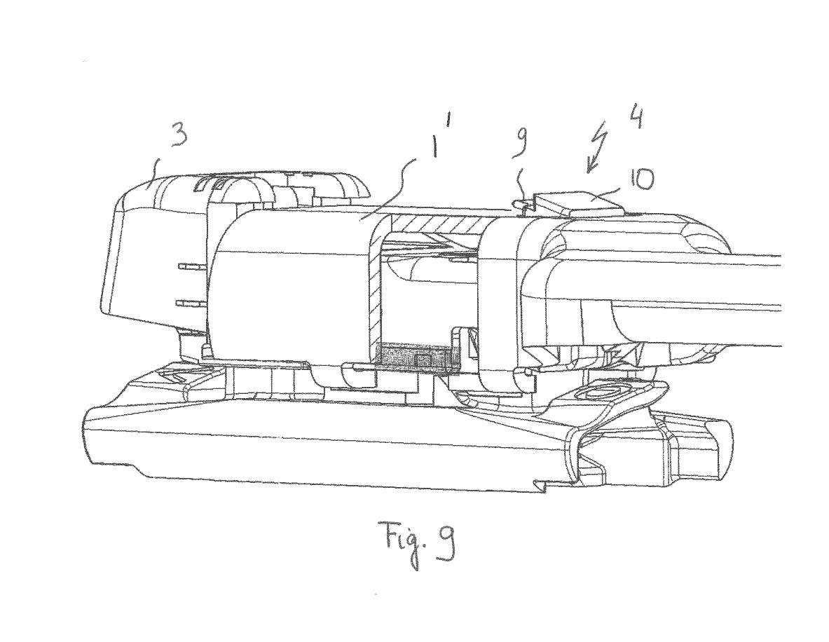

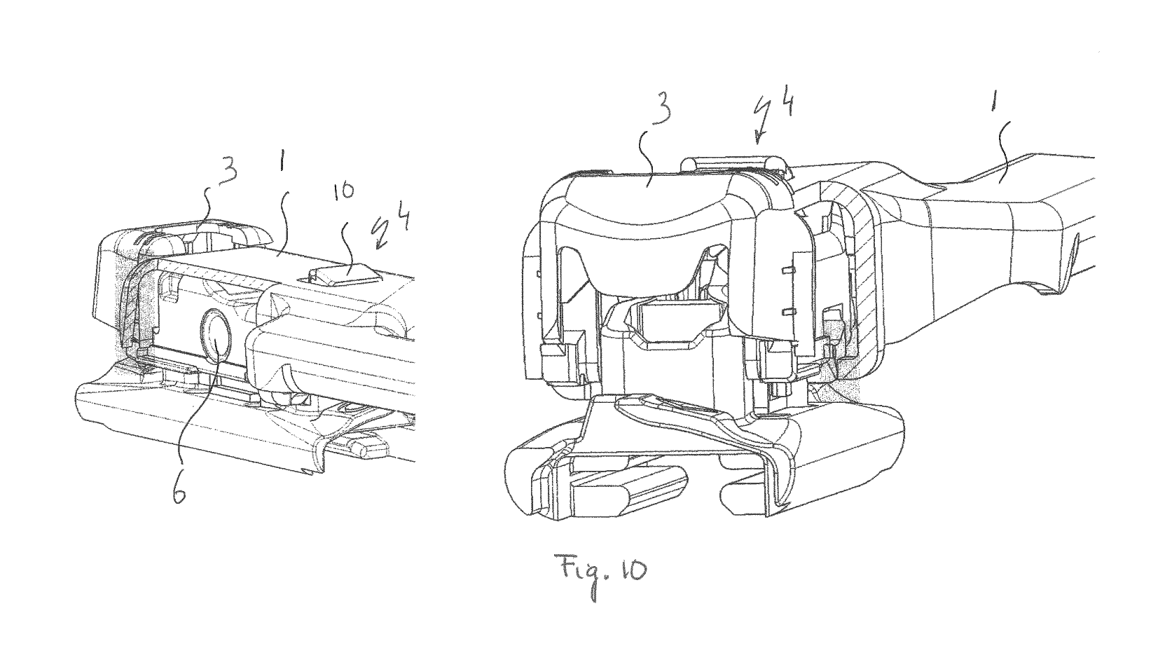

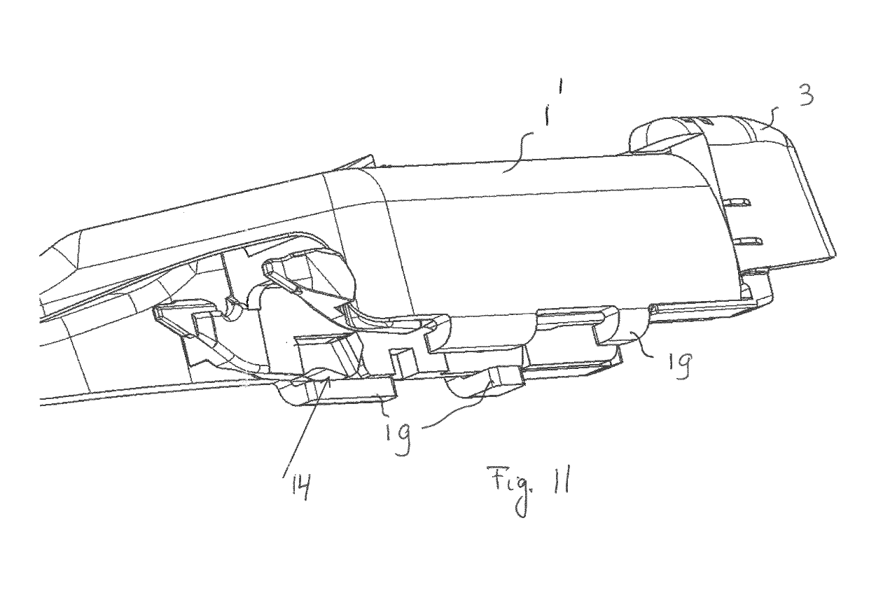

FIGS. 9, 10 and 11 are further views on the interconnection between the joint part 3 and the oscillating arms 1, 1′, respectively, wherein corresponding parts have been designated with the same reference numerals.

The invention is not restricted to the variants shown in the drawing, but it also extends to other embodiments that fall within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, a joint part having at least one resilient tongue arranged to engage into a correspondingly shaped hole provided in a base of a U-shaped cross-section of the oscillating arm, wherein said resilient tongue is hingeable between a inward position, wherein said wiper blade can be released from the oscillating arm, and an outward position, wherein said wiper blade can be retained on the oscillating arm, wherein said resilient tongue comprises a first step and a second step, wherein said first step is arranged to abut an edge of a hole of an oscillating arm of a first type facing towards a free end thereof, wherein said second step is arranged to abut an edge of a hole of an oscillating arm of a second type facing towards a free end thereof, and wherein the oscillating arm of the first type and the oscillating arm of the second type mutually differ in a distance between legs of the U-shaped cross-section of said oscillating arms.

2. The windscreen wiper device according to claim 1, wherein an upper surface of said first step is located closer to said wiper blade than an upper surface of said second step.

3. The windscreen wiper device according to claim 1, wherein a distance between the legs of the U-shaped cross-section of the oscillating arm of the first type is 22 mm, and wherein a distance between the legs of the U-shaped cross-section of the oscillating arm of the second type is 19 mm.

4. The windscreen wiper device according to claim 1, wherein said joint part has an at least substantially U-shaped cross-section at a location of its attachment to said connecting device, wherein at least one leg of said U-shaped cross-section of said joint part comprises an attaching lug, and wherein said attaching lug is arranged to snappingly engage a corresponding leg of the U-shaped cross-section of the oscillating arms of the first type and the second type.

5. The windscreen wiper device according to claim 4, wherein said attaching lug comprises a protrusion extending laterally inwardly, and wherein said attaching lug is hingeable between a downward position, wherein said wiper blade can be released from the oscillating arms of the first type and the second type, and an upward position, wherein said wiper blade can be retained on said oscillating arms of the first type and the second type and wherein said protrusion is arranged to snap behind said corresponding leg of said U-shaped cross-section of the oscillating arms of the first type and the second type.

6. The windscreen wiper device according to claim 4, wherein said attaching lug comprises a protrusion extending laterally inwardly, and wherein said attaching lug can be pushed in and out in longitudinal direction between a inward position, wherein said wiper blade can be released from the oscillating arms of the first type and the second type, and an outward position, wherein said wiper blade can be retained on the oscillating arms of the first type and the second type and wherein said protrusion is arranged to snap into a correspondingly shaped recess of said corresponding leg of said U-shaped cross-section of the oscillating arms of the first type and the second type.

7. The windscreen wiper device according to claim 5, wherein said joint part comprises a cam, and wherein said cam and said attaching lug are arranged to longitudinally retain between them the legs of the U-shaped cross-section of the oscillating arm of the first type.

8. windscreen wiper device according to claim 5 or 6, wherein said connecting device comprises a cam, and wherein said cam and said attaching lug are arranged to longitudinally retain between them the legs of the U-shaped cross-section of the oscillating arm of the second type.

9. The windscreen wiper device according to claim 1, wherein each leg of the U-shaped cross-section of the oscillating arms of the first type and the second type comprises clamping members engaging around longitudinal sides of said joint part that. face away from each other.

10. The windscreen wiper device according to claim 1, wherein said joint part is made of plastic.

11. The windscreen wiper device according to claim 1, wherein said joint part is detachably connected to said connecting device by pivotally engaging protrusions of said connecting device at the location of said pivot axis into recesses provided in said joint part.

12. The windscreen wiper device according to claim 1, wherein said joint part has an at least substantially U-shaped cross-section at the location of its attachment to said connecting device, and wherein each leg of said U-shaped cross-section is provided with a recess provided coaxially with said pivot axis.

13. A vehicle provided with a windscreen wiper device according to claim 1.

14. A method for manufacturing a windscreen wiper device of the fiat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein said oscillating arm can be pivotally connected to said connecting device about a pivot axis near one end, with the interposition of a joint part, wherein said joint part comprises at least one resilient tongue arranged to engage into a correspondingly shaped hole provided in a base of a U-shaped cross-section of said oscillating arm, wherein said resilient tongue is hingeable between an inward position, wherein said wiper blade can be released from said oscillating arm, and an outward position, wherein said wiper blade can be retained on said oscillating arm, wherein said resilient tongue comprises a first step and a second step, wherein said first step is arranged to abut an edge of said hole of an oscillating arm of a first type facing towards a free end thereof, wherein said second step is arranged to abut an edge of said hole of an oscillating arm or second type facing towards a free end thereof, and wherein said oscillating arm of the first type and said oscillating arm of the second type mutually differ in a distance between legs of the U-shaped cross-section of said oscillating arms.
